(19) United States
(12) Patent Application Publication
(10) Pub. No.: US 2009/0321552 A1
(43) Pub. Date: Dec. 31, 2009

(54) Moldable paper product

(76) Inventors: Frank Stephen Hada, Appleton, WI (US); Megan Kathryn Millard, Appleton, WI (US); Heather Anne Sorebo, Appleton, WI (US); Kenneth John Zwick, Neenah, WI (US)

Correspondence Address: KIMBERLY-CLARK WORLDWIDE, INC.;Tara Pohlkotte, 401 NORTH LAKE STREET, NEENAH, WI, 54956, US

(21) Appl. No.: 12/215,484

(22) Filed: Jun. 26, 2008

(51) Int. Cl. B65H 75/28; B32B 29/00; B42D 19/00

(52) U.S. Cl. 242/583; 428/153; 281/5

(57) ABSTRACT

A paper towel sheet is disclosed which contains a low strength adhesive material strategically applied to selected areas of the sheet. The adhesive areas enable the user to optionally fold and form the sheets into three-dimensional shapes suitable for a variety of new uses, such as making “bowls” for holding popcorn or other food, for example.

### BACKGROUND OF THE INVENTION

Paper towels have a wide variety of uses. While mostly used to clean up spills or otherwise wipe surfaces, they are sometimes used to hold foods such as pizza, popcorn, other snack foods and the like in locations away from the kitchen or dining table. When a person is finished eating, the paper towel may still serve to clean one's hands. Unfortunately paper towels are flat and flexible and do not do a good job of containing food and crumbs. Paper plates are better suited for containment purposes, but they are more expensive and generally not as readily available as paper towels. Furthermore, even when using paper plates, one may still need a paper towel or napkin to clean one's hands after eating certain foods and to wipe or clean up. The disposal of paper plates is also awkward as they can take up a lot of room in the waste container, while a paper towel can be disposed of more easily. Therefore there is a need for an inexpensive product that provides the convenience and cleaning ability of paper towels while providing improved food containment like a paper plate.

### SUMMARY OF THE INVENTION

It has now been discovered that paper towel sheets can be provided with strategically placed areas of adhesive, such that the paper towel sheet can be folded and selectively adhered to itself to form a three-dimensional shape that can be used as a soft, pliable container for food or for a variety of other uses. When finished, the paper towel sheet can be unfolded and used for wiping, such as a substitute for a napkin. It can be seen that a product such as this can be used for a number of other uses such as, without limitation, covers for food in a microwave oven.

Hence in one aspect, the invention resides in a paper towel sheet, said sheet having a top side, an opposing bottom side, and four edges, said sheet further comprising an adhesive area on at least one side of the sheet, said adhesive area positioned to enable the sheet to be folded upon and adhered to itself. More particularly, the adhesive area can be positioned along at least two opposing edges, suitably along all four edges. The adhesive area will be described in more detail below.

In another aspect, the invention resides in a roll of paper towel sheets, each of said sheets separated and detachable from each other by transverse lines of perforation, said sheets having a top side, an opposing bottom side, a first outer edge, an opposing second outer edge, a first perforated edge and an opposing second perforated edge, wherein one or more sheets within the roll contains an adhesive area on at least one side of the sheet, said adhesive area positioned to enable the sheet to be folded upon and adhered to itself. The number of sheets on the roll that contain adhesive as described herein can be any number as determined by market demand. For example, suitably all of sheets on the roll can contain adhesive. Alternatively, the adhesive-containing sheets can be every other sheet, or every third sheet, or every fourth sheet, and so on. In all embodiments, but particularly in those embodiments where the adhesive-containing sheets are not every sheet within the roll, it can be advantageous to color or otherwise provide a visual indication of the location of the adhesive areas.

While primarily described herein in connection with rolls of paper towel sheets, it will be appreciated that the paper towel sheets of this invention can also be provided and dispensed from forms other than a roll. For example, the paper towel sheets can be folded and stacked and dispensed from a carton, such as some facial tissues and paper towels. Alternatively, the paper towel sheets of this invention can be presented as a pad of individual sheets linked together at one edge to form a pad.

Hence, in another aspect, the invention resides in a pad of paper towel sheets, each of said sheets separated and detached from each other and assembled in a stack, said sheets having a top side, an opposing bottom side, two opposing outer side edges and opposing front and back edges, wherein each sheet within the stack contains an adhesive area on at least one side of the sheet, said adhesive area positioned to enable the sheet to be folded upon and adhered to itself, and wherein each sheet within the stack contains an adhesive area along the back edge on at least one side of the sheet which attaches the sheet to the other sheets within the stack. The adhesive present on one or both sides of each sheet can serve to hold the pad together and dispensing of the sheets is accomplished by simply peeling each sheet away from the pad. The adhesive on the back edge of the sheet can be the same as or different from the adhesive used to adhere the folded sheet to itself. For this purpose, it can be advantageous to provide adhesive along the back edge on both sides of the sheet. A pad of Post-It® notepaper manufactured by the 3M Corporation of Minneapolis, Minn. is a good example of a pad formed by using adhesive to form the pad out of individual sheets. The same approach can be applied to the pad of sheets of this invention. Those skilled in the adhesive arts will be able to select an appropriate adhesive for this purpose without undue experimentation. Alternatively, a pad of paper towel sheets can be assembled by organizing the pad into a stack and applying adhesive to one edge of the stack. Using this method any of the edges of the stack can be used to form the pad of paper towel sheets regardless of the pattern of adhesive on each individual sheet.

As used herein, paper towel sheets are absorbent, low density products made from cellulose papermaking fibers as are well known in the art. Suitable papermaking fibers include, without limitation, softwood fibers, hardwood fibers, man-made fibers and blends thereof. The paper towel sheet products can be a single-ply or they can include multiple plies. The plies can be layered, which means that the concentration of the different fibers varies based on a predetermined recipe through the thickness of the sheet, or the plies can be homogenous (blended). In all cases, the permeability and absorbency of each side of the paper towel sheet can optionally be adjusted for use as a container. For example, one side of the paper towel sheet can be made relatively impermeable to prevent the migration of grease or oils, while the other side can be made absorbent and permeable to be used for wiping. Adhesive areas can be present on either side of the sheet to permit the relatively impermeable side to form the inside or the outside of the container, as desired. Impermeable plies or layers can be made from treated paper or fibers, combinations of cellulose fibers and plastic fibers, impermeable coatings, or sheets of plastic-like materials.

As used herein, “absorbent” means being able to absorb about 4 grams of water or greater per gram of fiber, more specifically about 5 grams of water or greater per gram of fiber, and still more specifically from about 4 or 5 to about 10 grams of water per gram of fiber. For purposes herein, absorbency can be determined by the “vertical absorbent capacity” test. In particular, the vertical absorbent capacity is determined by cutting a sheet of the product to be tested (which may contain one or more plies) into a square measuring 100 millimeters by 100 millimeters (±1 mm.) The resulting test specimen is weighed to the nearest 0.01 gram and the value is recorded as the “dry weight”. The specimen is attached to a 3-point clamping device and hung from one corner in a 3-point clamping device such that the opposite corner is lower than the rest of the specimen, then the sample and the clamp are placed into a dish of water and soaked in the water for 3 minutes (±5 seconds). The water should be distilled or de-ionized water at a temperature of 23±3° C. At the end of the soaking time, the specimen and the clamp are removed from the water. The clamping device should be such that the clamp area and pressure have minimal effect on the test result. Specifically, the clamp area should be only large enough to hold the sample and the pressure should also just be sufficient for holding the sample, while minimizing the amount of water removed from the sample during clamping. The sample specimen is allowed to drain for 3 minutes (±5 seconds). At the end of the draining time, the specimen is removed by holding a weighing dish under the specimen and releasing it from the clamping device. The wet specimen is then weighed to the nearest 0.01 gram and the value recorded as the “wet weight”. The vertical absorbent capacity in grams per gram=[(wet weight−dry weight)/dry weight]. At least five (5) replicate measurements are made on representative samples from the same roll, box or pad of product to yield an average vertical absorbent capacity value.

Paper towels can also be characterized by their relatively low density compared to flat grades of paper. As used herein, “low density” means a sheet bulk of about 3 cubic centimeters or greater per gram of fiber, more particularly about 5 cubic centimeters or greater per gram of fiber, more particularly about 10 cubic centimeters or greater per gram of fiber, and still more particularly from about 10 to about 20 cubic centimeters per gram of fiber. Sheet bulk is calculated as the quotient of the sheet “caliper” (hereinafter defined), expressed in microns, divided by the basis weight, expressed in grams per square meter. The resulting sheet bulk is expressed in cubic centimeters per gram. More specifically, the sheet caliper is the representative thickness of a single sheet measured in accordance with TAPPI test methods T402 “Standard Conditioning and Testing Atmosphere For Paper, Board, Pulp Handsheets and Related Products” and T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg. The micrometer has a load of 2 kilo-Pascals, a pressure foot area of 2500 square millimeters, a pressure foot diameter of 56.42 millimeters, a dwell time of 3 seconds and a lowering rate of 0.8 millimeters per second.

As used herein, an “adhesive” is a material that adheres to itself with sufficient strength to hold the folded paper towel sheets in the desired folded configuration, yet has sufficiently low tackiness or strength so that it does not tear the paper towel sheets as they are unwound and removed from the roll or pad, or otherwise interfere with normal paper towel uses in cases where the paper towel sheets are not used to form a folded container. The particular adhesive to be used can be determined without undue experimentation by those familiar with adhesives, and will partly depend upon the desired adhesive pattern to be applied to the sheet and the individual sheet properties. Adhesive areas or patterns that cover a relatively large portion of the surface area of the sheet, particularly those having a relatively dense microscopic pattern of adhesive deposits within the adhesive area, can utilize adhesives that are less aggressive (less tacky). Conversely, adhesive patterns that cover a smaller portion of the surface area of the sheet, or have a relatively less dense microscopic pattern of adhesive deposits within the adhesive area, such as widely-spaced small dots, may need to be more aggressive (more tacky) in order to achieve the purposes described herein.

In general, suitable adhesives can be pressure-sensitive adhesives of any type, such as are known in the adhesive arts. A particularly suitable sub-class of adhesives is cohesives or cold seal adhesives, which are materials that bond to themselves, but not other materials. Such adhesives are formed by blending an adhesive component with an elastomeric component to provide cohesive strength. Suitable elastomers include natural (natural rubber) and synthetic elastomers. Suitable adhesive components include vinyl acetate and acrylic polymers. Particular commercial examples of suitable adhesives are those used on Post-It® notes from 3M, the repositionable adhesive used in 3M Spray Mount 6065, Co-Seal™ from Rohm and Haas, and Nip-Weld® from Bostik. Particularly suitable adhesives are acceptable for food-grade use, including the ability to maintain their tackiness and release properties after being used in the microwave oven.

When used on a roll of paper towels, the tackiness of the adhesive while in the roll needs to be controlled to allow easy dispensing of the sheets from the roll without tearing the sheets. To this end, the adhesives can have a peel strength (defined below) of from about 1 to about 25 grams when attached to the back of the sheet, as when wound into a roll. More specifically, the peel strength can be from about 1 to about 20 grams, more specifically from about 1 to about 15 grams, and still more specifically from about 1 to about 10 grams. “Peel strength” can be measured by a modified version of the Peel Test described in ASTM D5170-98—Standard Test Method for Peel Strength (“T” Method) of Hook and Loop Touch Fasteners, but with the following exceptions in order to adapt the method from hook and loop testing to tissue testing (modified ASTM section numbers are shown in parenthesis):

(a) Replace all references to “hook and loop touch fasteners” with “tissue samples”.

(b) (Section 3.3) Only one calculation method is used, namely the “integrator average” or average force over the measured distance.

(c) (Section 4.1) No roller device is used.

(d) (Section 6. Specimen Preparation) Replace all contents with the following:

“The level of blocking that will occur naturally over prolonged aging under pressure in a wound roll can be simulated by conditioning the samples in an oven under pressure. To artificially block samples, the 2 sheet specimens to be blocked together are cut to 76.2±1 mm (3±0.04 inches) in the cross direction by 177.8±25.4 mm (7±1 inch) in the machine direction. The specimens are then stacked back to front so that the side of the sheet facing the outside of the roll is contacting the side of the other sheet that faces the inside of the roll. The specimens are then placed on a flat surface in an oven operating at 66° C. On top of the specimens is placed a lightweight polycarbonate plate. On top of the polycarbonate plate, centered on the sample strips, is placed an iron block weighing approximately 11,800 grams and having a bottom face area of 10.2 cm×10.2 cm. The samples are stored in the oven under the applied weight for 1 hour. When the samples are removed from the oven, they are allowed to equilibrate under no additional weight for at least 4 hours in standard TAPPI conditions (25° C. and 50% relative humidity) prior to conducting the blocking test.

(e) (Section 8. Procedure) Replace all contents with the following:

“Separate the top and bottom sheet of the specimen along the CD (3 inches) edge. Peel back approximately 51 mm (2 inches) of the top and bottom sheets in the machine direction. Position the clamps of the tensile tester so they are 25.4±1 mm (1±0.04 inches) apart. Place the free ends of the specimen to be tested in the clamps of the tensile tester, with the specimen tail facing away from the frame. The point of specimen separation should be approximately centered between the clamps and aligned approximately parallel to the clamps. For the integrator calculation, set up the software to begin averaging after 25.4 mm (1 inch) of separation and end averaging after 88.9 mm (3.5 inches) of separation. The software should be set up to separate the sample over a total of 101.6 mm (4 inches).”

(f) (Section 9. Calculation) Omit all but 9.2.

(g) (Section 10. Report) Replace all contents with the following:

“Report the integrator average for each specimen.”

(h) (Section 11.1) Replace all contents with the following:

“At least 5 specimens should be tested for a reliable sample average.”

As used herein, an adhesive “area” is a macroscopically large area, such as depicted in the drawings, consisting of a plurality of small (microscopic) individual adhesive deposits or a continuous or discontinuous film of adhesive. The adhesive area is defined by the perimeter (overall pattern) of the plurality of small individual deposits or the perimeter (overall pattern) of the film. It can suitably be provided by spraying or printing.

Methods of applying the adhesive particularly include printing and spraying during converting operations when the paper towel basesheet is unwound from a parent roll, rewound into logs and slit into individual paper towel rolls. Printing is particularly advantageous because it provides the greatest flexibility in terms of overall patterns, pattern density and precision, particularly if adhesive is to be applied along the perforated cross-machine direction (transverse) edges of the sheet. This can be advantageously done by combining the perforation and the adhesive application unit into one roller. Aligning the printing pattern to the perforation (registration) is known in the art. It will be appreciated that a wide variety of adhesive area patterns can be used, with or without registration between the perforation and the printing pattern. In one embodiment, a suitable adhesive area pattern would be a continuous band of adhesive along one or both of the non-perforated edges of the sheet, the band of adhesive being sufficiently wide to allow molding the sheet into a three-dimensional shape.

To produce a product form consisting of a pad of individual sheets, a roll of previously-prepared base material is unwound, slit into the appropriate width, or multiple of widths depending on the base material width, printed with the appropriate adhesive pattern on one or both sides, and then cut into sheets. The adhesive area pattern is preferably matched to the cutting pattern to make the adhesive area appear in the same relative location on each sheet. Individual sheets are then assembled into pads and, if necessary, glue is applied to one edge of the sheet by a roller, spraying or by dipping the end of the stack of sheets into a cold or hot-melt adhesive. It can be seen that registration of the adhesive area pattern to each individual sheet would be an inherent feature of this process.

It will be appreciated that there are an infinite number of adhesive area patterns that can be used in accordance with this invention. Suitably, if adhesive is applied in a band along the edges of the sheet (including only the outer edges of the sheet, only the perforated edges of the sheet, or both the outer edges and the perforated edges of the sheet), the width of the band of adhesive can be from about 5 to about 40 percent of the width of the sheet in each direction. Adhesive area patterns confined to within about 1 or 2 inches of the edges of the sheet are particularly advantageous in that they provide a balance of functionality and adhesive cost. However, patterns with greater sheet coverage, up to covering the entire surface of the sheet with adhesive, can be used. Such patterns are limited only by the design of the printing rolls or other means that can be used to deliver the deposits. The size, spacing, tackiness, shape and placement of the adhesive areas (including the size and spacing of the individual microscopic adhesive deposits within the overall macroscopic adhesive area pattern), will be influenced by any detrimental impact on the performance of the towel sheet for the normal towel usages, as well as adhesive cost considerations.

In addition, the adhesive areas of the sheet can be colored or otherwise made distinctive from the balance of the sheet in order to indicate to the user where the adhesive is present. Besides a color difference, visual distinctiveness can be imparted by shading or differences in decorative print patterns. Printing patterns that are added to the sheet can also be used as an aid to the user in making the folding of the sheet into predetermined shapes more intuitive, including printing numbers to indicate the order of folding. Alternatively, distinctiveness can be provided by texture differences, such as by the presence or absence of an embossing pattern, or a different embossing pattern. An embossing pattern can also be used to crease or weaken the sheet in the appropriate locations to make folding the container easier for the user. In addition, if the adhesive pattern is made known to the user via packaging, advertising or other means and marking the sheet with the location of the adhesive is not warranted, in cases where not all of the sheets within the roll or the pad contain adhesive, the adhesive-containing sheets may still be provided with some indicia, such as a simple printed marker or identifier, that indicates which sheets within the roll or pad contain the adhesive. For example, if every third sheet contained the adhesive, every third sheet could be provided with a highly visible “dot” or other indicia to indicate the presence of the adhesive pattern on that sheet. Printing of the adhesive can also contain a logo, trademark or other indication of the company manufacturing the product.

### BRIEF DESCRIPTION OF THE DRAWINGS

FIG. 1 is a schematic illustration of a roll of paper towel sheets being unwound, illustrating the various structural terms used herein.

FIG. 2 is a schematic illustration of a paper towel sheet in accordance with this invention, illustrating the presence of adhesive area bands along the outside edges of the sheet.

FIG. 3 is a schematic illustration of the paper towel sheet of FIG. 2 after being folded into a container.

FIG. 4 is a schematic illustration of a paper towel sheet (similar to that of FIG. 2, but having adhesive areas on both sides of the sheet) after being folded into a container with the corners tacked down.

FIG. 5 represents an alternative adhesive area pattern that may be applied to one or both sides of the sheet.

FIG. 6 represents another alternative adhesive area pattern that may be applied to one or both sides of the sheet.

FIG. 7 is a schematic representation of a pad of paper towel sheets in accordance with this invention.

### DETAILED DESCRIPTION OF THE DRAWINGS

Referring to the Figures, the invention will be described in more detail. As used herein, the use of the same reference number in more than one Figure refers to the same feature.

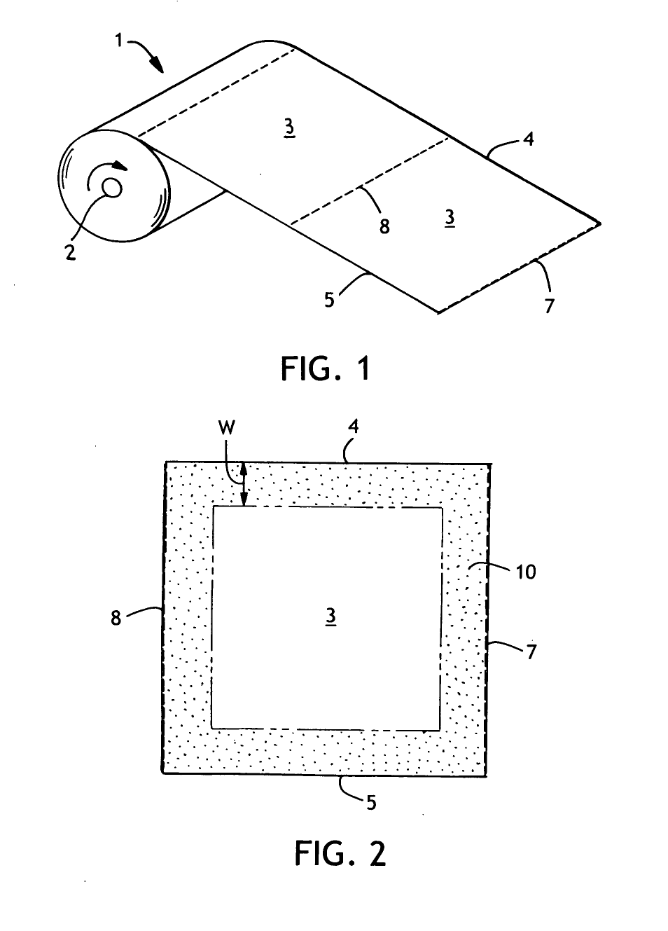

Directing attention to FIG. 1, shown is roll of paper towels 1 wound about an optional core 2. Individual sheets on the roll have a top side 3, an opposing bottom side (not visible in this view), a first outer edge 4, an opposing second outer edge 5, a first perforated edge 7 and an opposing second perforated edge 8. Obviously, while still on the roll, the second perforated edge of the leading sheet is the first perforated edge of the following sheet since they share a common perforated edge.

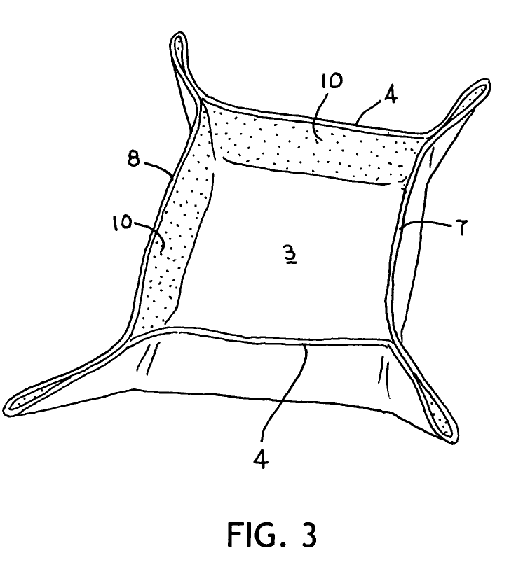

FIG. 2 illustrates a paper towel sheet in accordance with this invention having an adhesive area, in the form of a band, along all four outside edges of the top side of the sheet. If the sheet is provided from a roll of paper towels, edges 7 and 8 would be perforated. On the other hand, if the sheet is provided from a folded stack or pad, the edges 7 and 8 can be perforated or cleanly cut. Unless otherwise stated, the sheets of this invention will be described in connection with a roll of paper towels.

More specifically, shown is the adhesive area 10 represented by the shaded area. The adhesive area band has a width “W” which, in this embodiment, is the same along all four edges of the sheet. However, if desired, the width and/or shape of the adhesive area along each edge can be different. For example, it may example, it may be preferred to have more adhesive on the corners of the sheet, but narrow bands of adhesive on the edges of the sheet away from the corners. While it is desirable to have a large area of adhesive for purposes of offering flexibility in the types of containers to be formed, it is also desirable to leave much of the center area of the sheet unaltered to retain as much of the normal sheet properties as possible, such as absorbency, since the sheets may only occasionally be used to form containers. At other times, the sheets will be used for normal wiping, so it is important not to significantly impair, if at all, normal functionality to provide the additional container-forming capability. It is believed that an adhesive area band width extending about 2 inches in from the outer edges is a particularly suitable compromise. As previously mentioned, the adhesive area band can advantageously be present only along the outer edges and not along the perforated edges if the band is wide enough. Since the adhesive can be applied in a discontinuous pattern, such as a series of spaced-apart dots or lines, any impairment of the sheet absorbency by the adhesive can be minimized in the adhesive-containing areas of the sheet by optimizing the size and spacing of the adhesive deposits, both on a macroscopic and/or a microscopic scale.

In one embodiment, the adhesive can be applied solely to the bottom side of the sheet, which is the side of the sheet not visible when sheets are withdrawn and detached from the roll. This embodiment may be advantageous if the top side of the sheet is different than the bottom side of the sheet, or if the top side of the sheet is the side that is normally used to wipe surfaces. In such cases, the presence of an adhesive on the opposite side (in contact with the user's hand) would not be disadvantageous from the standpoint of absorbency or other performance characteristics and would provide an easy method to grip the sheet. The latent adhesive on the sheet can also be used to assist in the removal of crumbs or other small particles that have been dropped in the course of using the products of this invention as described herein.

Alternatively, the adhesive can be applied to both sides of the sheet, if desired, to provide the user with more options, although such embodiments would entail greater expense and processing complexity.

The adhesive can also be applied at different concentrations in different adhesive areas of the sheet by varying the microscopic adhesive deposit spacing and depth of each deposit for each location. For example, the peel strength or tackiness of the adhesive area can be made to be stronger on the corners of the sheet and weaker between the corners to reinforce higher stressed areas of the three-dimensional folded structure.

FIG. 3 is a schematic perspective view of a generally square three-dimensional container formed from the sheet of FIG. 2 after its four corners have been pinched and adhered together using the portions of the adhesive area band in the immediate area of four corners of the sheet. A more rounded container could be formed by also pinching together portions of the sheet edges midway between the corners. Note that it would be possible to adjust the size of the enclosed area relative to the height of the sides by adjusting the amount of material that is pinched to form the sides. For example, a low-sided bowl would be beneficial for popcorn, but a high-sided bowl would be useful to hold a cold or hot drink cup.

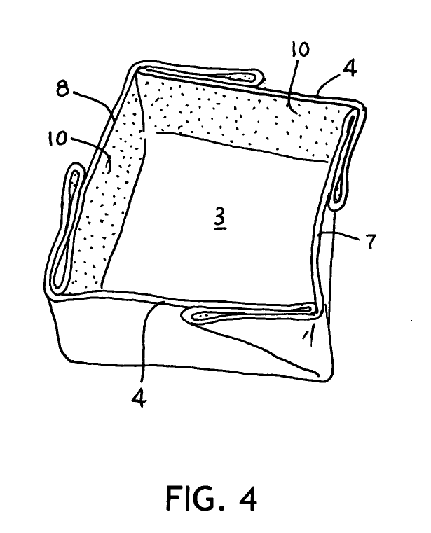

FIG. 4 is a schematic perspective view of a generally square bowl formed from a sheet similar to that of FIG. 2, except the adhesive area band has been applied to both (top and bottom) sides of the sheet in the same pattern illustrated in FIG. 2. As shown, this enables each of the pinched corners of the container of FIG. 3 to be folded to the side and adhered to an adjacent side of the container, thereby forming the container of FIG. 4, which somewhat resembles a bowl. Note that the adhesive area coverage can be the same or different on both sides of the sheet.

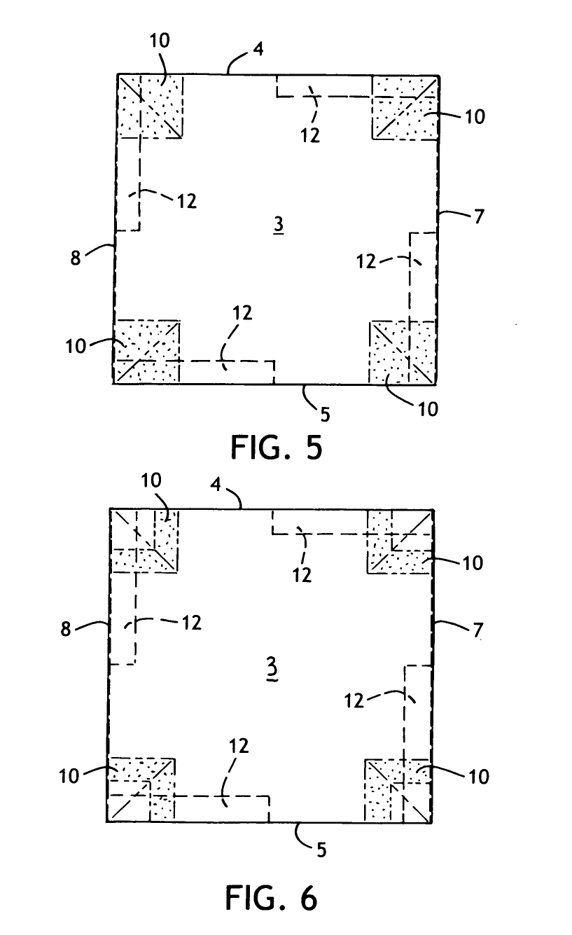

FIGS. 5 and 6 illustrate alternate adhesive area patterns that may be applied to one or both sides of the sheet. These patterns would be more cost-effective in terms of adhesive usage in that they target only the areas necessary to make the containers of FIGS. 3 and 4. For both FIGS. 5 and 6, the shaded areas 10 represent the adhesive areas on the top side of the sheet. In both embodiments, the adhesive is applied only in the areas in which it is needed, namely the corners of the sheet. The angled dashed lines in each corner represent anticipated fold lines when the corners are pinched together to form the container. Optionally, these anticipated fold lines in each corner of the sheet can be printed be printed onto the sheet to visually indicate to the user where to fold the sheet. Also, shown in phantom lines along about half of the length of each side of the sheet are adhesive areas 12 along the edges of the second side of the sheet that can be used to tack down the folded corners in order to produce the bowl-shaped container of FIG. 4. These areas can extend partially or completely along the edges as desired. As shown in FIG. 5, the adhesive areas 10 on the top side corners of the sheet are generally square-shaped areas, whereas in FIG. 6 the adhesive areas in the corners are “L-shaped”. In all embodiments of the invention, the pattern or shape of the adhesive areas on the bottom side of the sheet can be the same or different than the shape of the adhesive areas on the top side of the sheet.

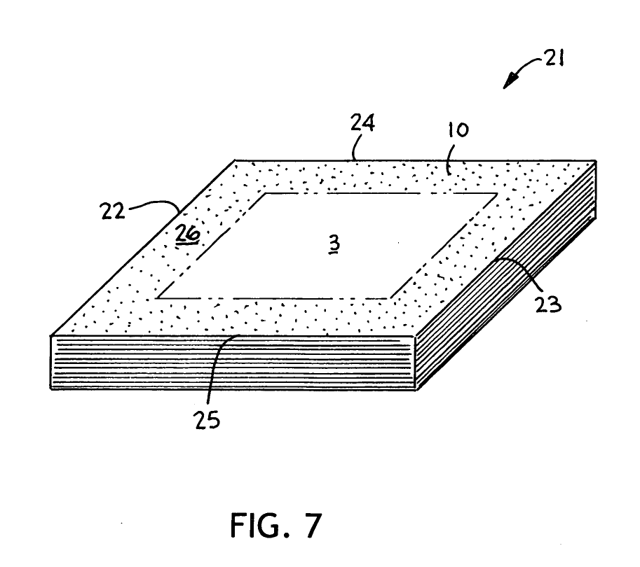

FIG. 7 illustrates a pad 21 of paper towel sheets in accordance with this invention. Shown is the back edge 22, the front edge 23, opposing side edges 24 and 25, the adhesive area 10 and the top side of the sheet 3. For normal adhesives, the adhesive areas on the top side of the sheets will adhere each sheet to the one above it in the pad. However, if the adhesive is a cohesive, which essentially only adheres to itself, it is necessary to provide another means of attaching the sheets together to form the pad. This can be done by also providing the cohesive on the bottom side of the sheet along one of the edges, preferably along the back edge of the sheet, such as the area on the bottom side of the sheet corresponding to area 26 shown on the top side. This will enable each sheet to adhere to the sheet above and below it within the stack. Alternatively, the edge of the pad can be printed or otherwise provided with an adhesive after the stack is assembled as previously described.

In the interests of brevity and conciseness, any ranges of values set forth in this specification contemplate all values within the range and are to be construed as written description support for claims reciting any sub-ranges having endpoints which are whole number or otherwise of like numerical values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5. Similarly, a disclosure in this specification of a range from 0.1 to 0.5 shall be considered to support claims to any of the following ranges: 0.1-0.5; 0.1-0.4; 0.1-0.3; 0.1-0.2; 0.2-0.5; 0.2-0.4; 0.2-0.3; 0.3-0.5; 0.3-0.4; and 0.4-0.5. In addition, any values prefaced by the word “about” are to be construed as written description support for the value itself. By way of example, a range of “from about 1 to about 5” is to be interpreted as also disclosing and providing support for a range of “from 1 to 5”, “from 1 to about 5” and “from about 1 to 5”.

It will be appreciated that the foregoing figures and description, given for purposes of illustration, are not to be construed as limiting the scope of this invention, which is defined by the following claims and all equivalents thereto.

We claim:

1. A paper towel sheet, said sheet having a top side, an opposing bottom side, and four edges, said sheet further comprising an adhesive area on at least one side of the sheet to enable the sheet to be folded upon and adhered to itself.

2. The paper towel sheet of claim 1 containing one or more adhesive areas on the top side of the sheet.

3. The paper towel sheet of claim 1 containing one or more adhesive areas on the bottom side of the sheet.

4. The paper towel sheet of claim 1 containing adhesive areas on the top side of the sheet and adhesive areas on the bottom side of the sheet.

5. The paper towel sheet of claim 4, wherein the adhesive areas on the top side of the sheet are the same as the adhesive areas on the bottom side of the sheet.

6. The paper towel sheet of claim 4, wherein the adhesive areas on the top side of the sheet are different than the adhesive areas on the bottom side of the sheet.

7. The paper towel sheet of claim 1, wherein adhesive areas are colored.

8. The paper towel sheet of claim 1, wherein the adhesive areas are textured.

9. The paper towel sheet of claim 1, wherein adhesive areas are printed with folding lines.

10. The paper towel sheet of claim 1, wherein the adhesive areas are present only on one side of the sheet in a band along two opposing outer edges of the sheet, the band having a width from about 1 to about 2 inches.

11. The paper towel sheet of claim 1, wherein the adhesive areas are present only on one side of the sheet in a band along all four outer edges, the band having a width from about 1 to about 2 inches.

12. The paper towel sheet of claim 1, wherein the adhesive areas are present on the top and bottom sides of the sheet in a band along all four outer edges of the sheet, the band having a width from about 1 to about 2 inches.

13. The paper towel sheet of claim 1, wherein the adhesive areas are present on the top and bottom sides of the sheet in a band along all four outer edges of the sheet, the band having a width from about 5 to about 40 percent of the width of the sheet.

14. The paper towel sheet of claim 1, wherein the adhesive areas are present in each of four corners of one side of the sheet and along the edges of the opposite side of the sheet.

15. The paper towel sheet of claim 1, wherein the adhesive is activated by pressure.

16. The paper towel sheet of claim 1, wherein the adhesive is a cohesive.

17. A roll of paper towel sheets, each of said sheets separated and detachable from each other by transverse lines of perforation, said sheets having a top side, an opposing bottom side, a first outer edge, an opposing second outer edge, a first perforated edge and an opposing second perforated edge, wherein one or more sheets within the roll contains an adhesive area on at least one side of the sheet, said adhesive area positioned to enable the sheet to be folded upon and adhered to itself.

18. The roll of paper towel sheets of claim 17, wherein all of the sheets on the roll contain an adhesive area.

19. The roll of paper towel sheets of claim 17, wherein the sheets that contain an adhesive area are separated by one or more sheets that do not contain an adhesive area.

20. The roll of paper towel sheets of claim 19, wherein the sheets that contain an adhesive area are marked with a visual indicia.

21. A pad of paper towel sheets, each of said sheets separated and detached from each other and assembled in a stack, said sheets having a top side, an opposing bottom side, two opposing outer side edges and opposing front and back edges, wherein each sheet within the stack contains an adhesive area on at least one side of the sheet, said adhesive area positioned to enable the sheet to be folded upon and adhered to itself.

22. The pad of paper towel sheets of claim 21, wherein each sheet within the stack contains an adhesive area along the back edge on at least one side of the sheet which attaches the sheet to the other sheets within the stack.

23. The pad of paper towel sheets of claim 21, wherein each sheet contains an adhesive area along the back edge on both sides of the sheet.
